(19) United States
(12) Patent Application Publication
(10) Pub. No.: US 2008/0198280 A1
(43) Pub. Date: Aug. 21, 2008

(54) Light Module for Producing Light With a Scattering Pattern that is Electrically Variable and Use thereof as Multiple Purpose Light

(75) Inventors: Rifat Ata Mustafa Hikmet, Eindhoven (NL); Ties Van Bommel, Eindhoven (NL); Albrecht Kraus, Kerkrade (NL); Walter August Schlager, Bocholtz (NL); Johannes Petrus Maria Ansems, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/994,577

(22) PCT Filed: Jul. 4, 2006
(86) PCT No.: PCT/IB06/52245

§ 371 Date: Jan. 3, 2008

(30) Foreign Application Priority Data
Jul. 8, 2005 (EP) 05106246.1
Sep. 9, 2005 (EP) 05108295.6
Jan. 20, 2006 (EP) 06100659.9

(51) Int. Cl. G02F 1/1347

(52) U.S. Cl. 349/18

(57) ABSTRACT

The invention provides a light module (1) arranged to produce a beam of light (25) with a scattering pattern that is electrically variable. The module comprises a light source (2) arranged to provide a beam of light (5); and an electrically adjustable optical element (300) arranged to adjust the beam of light (5) from light source (2). The adjustable optical element comprises a first cell (10) with a first liquid crystal gel (11); optionally a polarization rotator (30); a second cell (20) with a second liquid crystal gel (21); and a unit 40 for applying a voltage across at least one of the first and second cells (10,20). Especially, the light module (1) provides a beam of light (25) with an anisotropic light distribution.

### FIELD OF THE INVENTION

The present invention relates to a light module for producing light with a scattering pattern that is electrically variable and to the use thereof as multiple purpose light.

### BACKGROUND OF THE INVENTION

In present cars a large number of light sources are used for fulfilling various functions as interior lighting within the car. Various spots are used as reading light and somewhat more diffuse lighting may be used as vanity and comfort lighting. There are also lamps placed by the car door(s) in order to enable illuminating the stepping area into the car. Hence, various light sources are used within cars fulfilling various functions such as reading light, vanity light, stepping light, etc.

An example of an interior car light is described in EP0669224. This document describes a courtesy lamp housing inside a car having two separate chambers with bulbs, one for map reading and one for general illumination. The lens of the reading lamp and its bulb, plus the wall dividing the two lamp chambers and the two contacts together form a single unit which fits inside the first lamp chamber and which can be removed for bulb replacement. Here, two lights are used for different purposes.

### SUMMARY OF THE INVENTION

A disadvantage of prior art interior car lights is that these lights may dazzle the driver. Further, prior art interior car lights usually produce a light beam of which the shape cannot be adapted and cannot be used for multiple purposes.

Hence, it is an aspect of the invention to provide a light module for producing light with a scattering pattern that is electrically variable. It is further an aspect of the invention to provide a multiple purpose light, especially for use in interior car lighting.

According to a first aspect of the invention, there is provided a light module for producing light with a scattering pattern that is electrically variable comprising:

a. a light source arranged to provide a beam of light; and
b. an electrically adjustable optical element arranged to adjust the beam of light from the light source, comprising:

1. a first cell with a first liquid crystal gel;

2. optionally a polarization rotator;

3. a second cell with a second liquid crystal gel; and

4. a unit for applying a voltage across at least one of the first and second cells,

Preferably, the first and the second cells and the optional polarization rotator are arranged to provide light with an anisotropic light distribution, i.e. to modify the beam of light into a beam of light with an anisotropic light distribution.

According to a next aspect of the invention, a controller for use in or for the light module, the controller being arranged to, in response to an adjusting control signal, controlling at least one element of a group of elements comprising the electrically adjustable optical element and the light source via at least one driving signal.

According to yet another aspect of the invention, there is provided a computer program product to be run on a controller, the computer program product comprising the function of, in response to an adjusting control signal, controlling at least one element of a group of elements comprising the electrically adjustable optical element and the light source via at least one driving signal of at least one light module according to the invention.

Further, according to another aspect of the invention, the invention enables the use of the light module according to invention as multiple purpose light, especially as multiple purpose interior car light.

### BRIEF DESCRIPTION OF THE DRAWINGS

Embodiments of the invention will now be described, by way of example only, with reference to the accompanying schematic drawings in which corresponding reference symbols indicate corresponding parts, and in which:

FIG. 1 schematically depicts a number of positions of interior car lights;

FIG. 2 schematically depicts the scattering of a beam of light;

FIG. 3 schematically depicts a scattering pattern as function φ and θ according to an embodiment of the invention;

FIG. 4 depicts the angular distribution of one polarization (referring to FIG. 3: for instance, φ is 135° or 315°) of scattered intensity obtained for a cell with a uniaxially oriented LC gel (liquid crystal gel) according to an embodiment of the invention as function of voltage;

FIG. 5 depicts the transmittance for a cell with a LC gel according to an embodiment of the invention as function of voltage for the same polarization as in FIG. 4;

FIG. 6a-6b schematically depict a number of embodiments of the light module according to the invention;

FIG. 7 schematically depicts an embodiment of the light module according to the invention;

FIG. 8 schematically depicts an embodiment of the light module according to the invention; and

FIG. 9a-9b schematically depict another embodiment of the light module according to the invention wherein the light module provides more than one beam of light.

### DESCRIPTION OF PREFERRED EMBODIMENTS

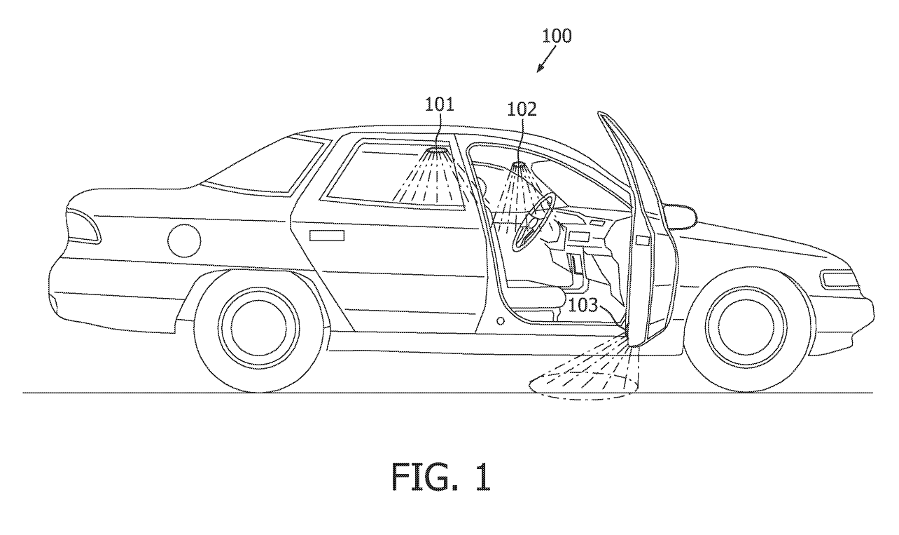

In present cars a large number of light sources are used for fulfilling various functions as interior lighting within the car. Various spots are used as reading light and somewhat more diffuse lighting is used as vanity and comfort lighting. Lamps are also placed at the car doors in order to enable for illuminating the stepping area into the car or out of the car. FIG. 1 shows embodiments of positions of various lamps used in a car 100, such as a vanity light 101, a reading light 102 and a stepping light 103. More positions of lights are possible, as will be clear to the person skilled in the art, for instance an interior light module at the interior car roof (for example arranged between the driver seat and passenger seat in the front or arranged above the back seat). State of the art lights may dazzle the driver, when the lights are not properly adjusted. Further, these lights cannot be used for multiple purposes. For example, state of the art reading light 102 cannot easily be adapted to further comprise a stepping light function.

Here a light module comprising a light source and an electrically adjustable optical element (especially an electrically induced scattering element) is described, which can change the shape of the beam of light upon application of an electric field. Furthermore, the scattering (or scattering pattern) can be achieved such that it can be highly anisotropic. Advantageously, the use of an adjustable optical element for adjusting the scattering pattern provides the possibility of combining various functions in a single light module. In this way for example a spot light (reading light) can be turned into a wide beam (comfort light, for instance a low intensity light with a broad distribution so that one can just see each other in the dark) or even further into ultra wide beam shape (stepping light or approaching light or general interior illumination light). Therefore, preferably the first and the second cells and the optional polarization rotator are arranged such that the light module provides a beam of light with an anisotropic light distribution.

Hence, in a specific embodiment the light module according to the invention can be used as multiple purpose light, especially as multiple purpose interior car light. Referring to FIG. 1, the car may be provided with a light module, wherein the use of the light module is selected from the group consisting of reading light, vanity light and stepping light. As will be clear to the person skilled in the art, more than one light module may be provided. Advantageously, the adjustable optical element can be arranged to provide adjusted light comprising a beam with an adjustable cone angle and/or an adjustable direction since the scattering angles can be electrically varied. The light module according to the invention is not only applicable in cars, but may also be used in trucks, busses, planes, trains, and automobiles, and may also be used for indoor and outdoor lighting, for devices like (pocket) lanterns, (pocket) torches, flash lights, illuminating lights, spectators, telescopes, (spy) glasses, still picture cameras, motion video cameras, mobile phones with camera functions, consumer devices like magnetrons, washing machines, dish washers, ovens, etc.

This light module is based on an anisotropic liquid crystal gel, which is amongst others described in EP0451905 or U.S. Pat. No. 5,188,760, which are herein incorporated by reference. The term “anisotropic liquid crystal gel” describes a system known to the person skilled in the art and is obtainable in the following way: a liquid crystalline mixture containing a polymerisable component (monomer which can lead to a cross-linked polymer upon polymerization) and non-polymerisable component (conventional LC used in displays) is formed. For photo-polymerization the system is provided with a photo initiator whereas for thermal polymerization the system is provided with a thermal initiator. The LC mixture is then placed in a suitable cell where macroscopic orientation in the LC is induced by orientation layers which are brought onto the cell surfaces. Upon polymerization of the monomer in the macroscopically oriented state, an anisotropic gel is obtained. Therefore, an anisotropic gel is a system wherein the LC molecules are macroscopically oriented and the polymer (polymerized network) is dispersed within the system. Such a gel is (substantially) transparent for light falling at all angles.

Herein, the term “liquid crystal gel” (LC gel) refers to a gel where a polymer is dispersed within a macroscopically oriented liquid crystal, as known to the person skilled in the art. For example, (photo)curable monomer is mixed in a LC host. The mixture is then injected into a LC cell with the proper surface treatment followed by (photo)polymerizing the (photo)curable monomer in the mixture of monomer and LC host.

For instance, anisotropic gels may be produced by photo polymerization of an oriented liquid crystalline (LC) mixture containing LC diacrylates and conventional LC molecules. In the voltage off state, the gel is transparent or substantially transparent, due to the ordered molecular alignment. When the voltage exceeds a threshold, the exerted torques from the electric field on the LC molecules cause their reorientation leading to the formation of domains with different orientation of the LC molecules. This variation in the orientation of molecules in different domains causes refractive index fluctuations leading to scattering of light. Light falling onto such an anisotropic gel can be scattered isotropically in all directions or preferentially (anisotropically) in a certain direction (range of angles) depending on the orientation and or configuration of the LC molecules as known to the person skilled in the art. Herein, the term anisotropic light distribution or anisotropic scattering pattern refers to a scattering pattern where iso-intensity lines (lines connecting the equal intensity points) do not form circles.

Herein, the term “director” refers to the molecular direction of preferred orientation in liquid crystalline mesophases. The term “mesophase” refers to an equilibrium liquid crystalline phases formed with order less than three dimensional (like crystals) and mobility less than that of an isotropic liquid. Parallel orientation of the longitudinal molecular axes is common to all mesophases (long-range orientation order). The term “twisted nematic” (TN) refers to a type of liquid crystal orientation configuration where the LC molecules rotate 90° from one surface to the other surface. The term “super twisted nematic” (STN) refers to a type of liquid crystal in which the liquid crystal molecules rotate more than 90° in the cell. Further, the term “cholesteric liquid crystals” refers to a LC crystal phase which is doped with so called chiral molecules which induce rotation in LC molecules. This phase is also known as chiral nematic. In the cholesteric phase, the distance over which the director rotates 360° is the pitch of the helix. Usually with increasing chiral molecule concentration within the system the pitch of the helix becomes smaller.

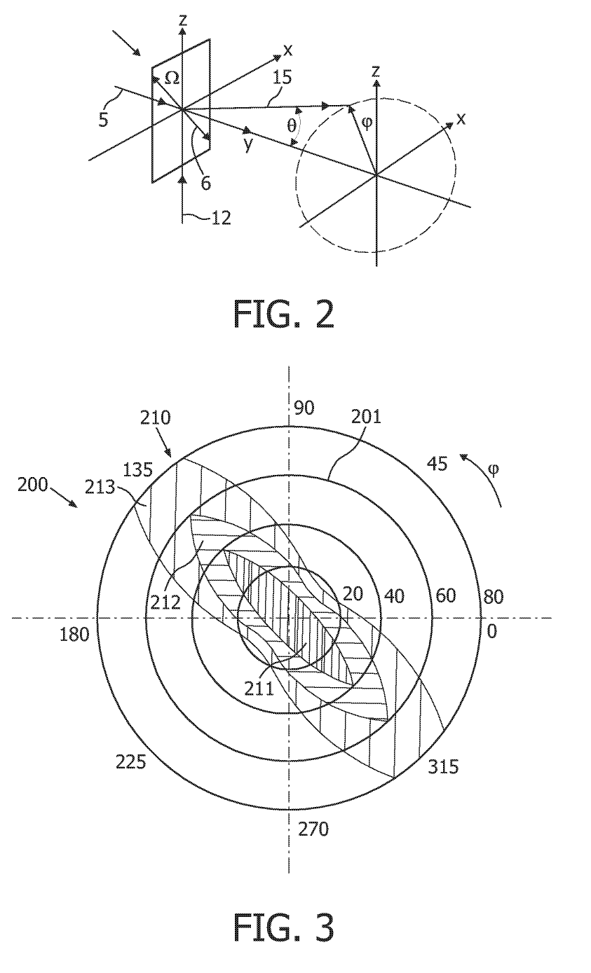

Light scattering is schematically indicated in FIG. 2, wherein reference number 5 indicates the incoming beam of light of a light source 2 (not shown here), which light source 2 is arranged to provide beam of light 5. In an embodiment, source 2 is selected from one or more of the group consisting of a halogen lamp, a xenon lamp, a LED, and a luminescent lamp. In an embodiment, LEDs are preferred. Hence, source 2 may comprise a number of LEDs or a luminescent lamp or one or more xenon lamps, etc. Source 2 may provide white light, but may also provide colored light. In general, source 2 will provide visible light, with radiation wavelengths in the range of about 400-700 nm, although the invention is not limited to these wavelengths. Light module 1 according to the invention may also be applied to other radiation like UV or (N)IR ((near) infra-red) radiation.

The beam of light 5 may for instance have a polarization component along the z-axis. Reference symbol Ω indicates the angle between the direction of molecular orientation and the plane of polarization of the polarization component. Reference number 15 refers to scattered beam of light 15 (after a first LC cell, see below), with scattering angles θ and φ, defining angles with respect to the horizontal y-axis and vertical z-axis, respectively.

Referring to FIG. 2 and assuming a molecular orientation of LC molecules in the gel along the z-axis in the electric field off state, upon application of an electric field across the cell containing an anisotropic liquid crystal gel, for a polarization component of beam of light 5 falling perpendicular to the molecular orientation (horizontally polarized, i.e. Ω is 90° (or 270°)) will almost not be scattered since there is no refractive index variation along its path. The other component of the light polarized in the direction of the molecular orientation (vertically polarized, Ω is 0° (or 180°)) will be scattered strongly due to variation of the refractive index along its path. This means that the component of light in beam of light 5 with a polarization direction perpendicular to the molecular orientation (i.e. director) is transmitted almost without being scattered.

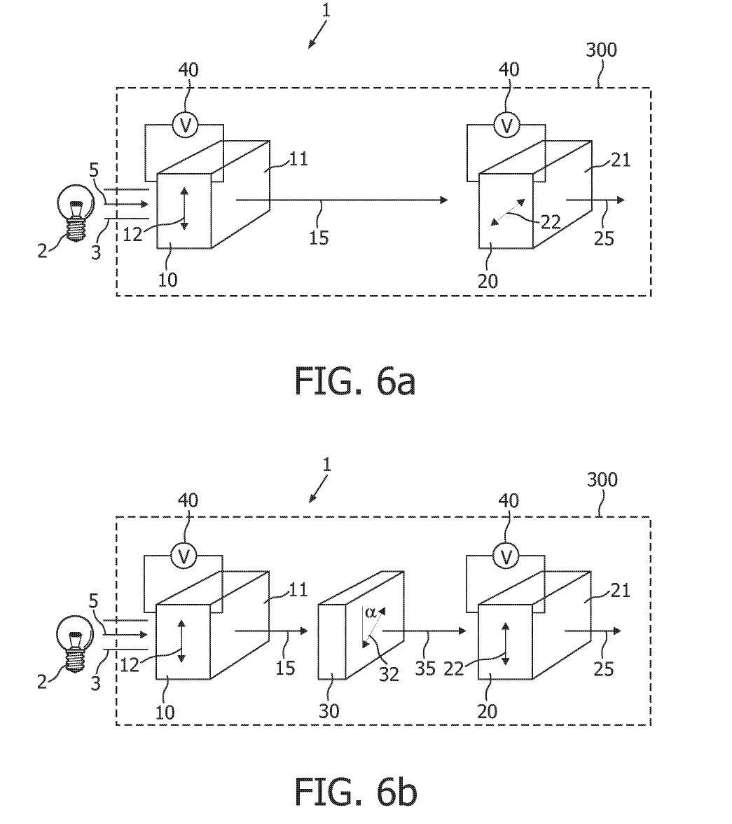

Referring to FIGS. 2 and 6a, light source 2 is arranged to provide a beam of light 5, which may optionally be influenced by a passive beam shaping element 3, for instance a collimator arranged to collimated beam 5. Beam of light 5 enters a cell (or element) 10 with a liquid crystal gel 11. Preferably, liquid crystal gel 11 is an anisotropic liquid crystal gel, more preferably an uniaxially oriented LC gel, even more preferably a liquid crystal gel comprising nematic liquid crystals. Over cell 10, a voltage may be applied, which, when applied, provides a beam 15 with anisotropic light distribution. The orientation direction of the LC molecules in the gel is indicated with director 12.

FIG. 3 schematically depicts a diagram 200 of a scattering pattern 210 as function φ and θ (at constant voltage applied over cell 10) that may be obtained according to an embodiment of the invention, especially an uniaxially oriented anisotropic LC gel as a LC gel 11. Here, FIG. 3 applies to one of the polarization directions (especially the polarization component of the light in beam of light 5 parallel to the orientation of the LC molecules). This Fig. is only an example; the intensity distribution or scattering pattern 210 obtained, depends amongst others on the orientation direction 12 of the LC molecules. Orientation direction 12 of the LC molecules in cell 10 is preferably in a plane perpendicular to beam 5. In this particular example orientation direction of the LC molecules is at an angle of Ω45°. Other angles Ω are of course possible. The diagram shown in FIG. 3 shows φ ranging (counterclockwise) from 0° (at the right side) through 90°, 180°, 270° back to 0° (which is also 360°). Intermediate values are also indicated. From the center of the diagram outwards, θ is varied. Some circles 201, indicating values for 0° are shown: 20°, 40°, 60° and 80°. Although not depicted, scattering pattern 210 may extend beyond circle 201 indicating 80°, since, in an embodiment of the invention, scattering angle θ may be almost 90°, i.e. scattering angle θ is smaller than 90° (at a given φ). In FIG. 3, scattering pattern 210 is schematically indicated with 3 regions: a first region 211 with relative high intensity, a second region 212 with intermediate intensity and a third region 213 with relative low intensity. Note that in reality, there will be a smooth transition from maximum intensity to zero intensity.

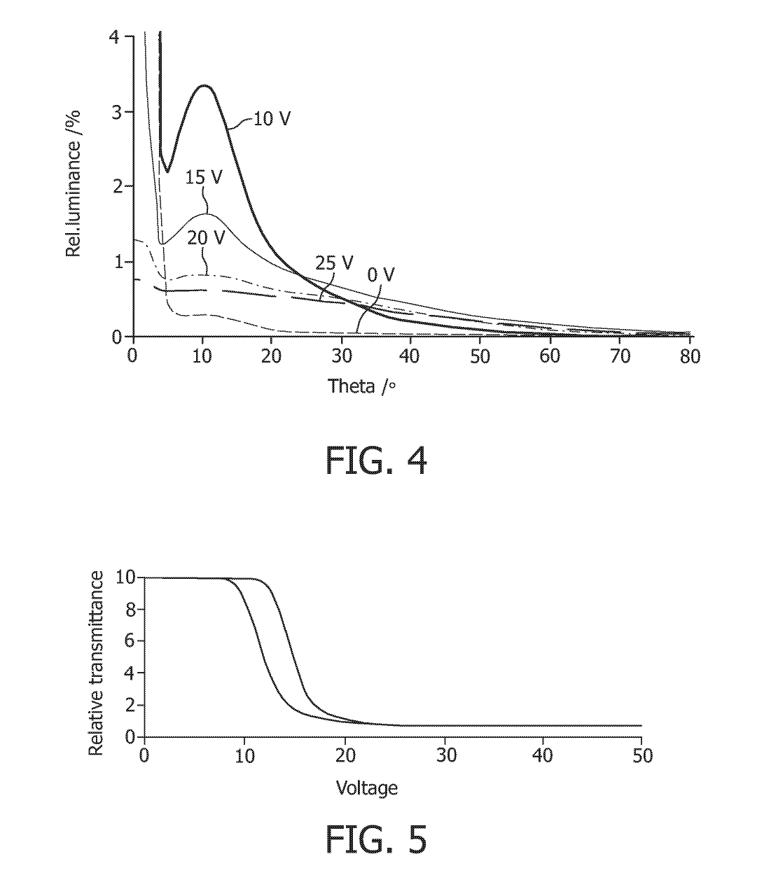

FIG. 4 shows an example of the angular distribution θ at a specific φ (referring to FIG. 3, for instance φ is about 135° or 315°) of the scattered intensity, for one polarization direction (in this example the plane of polarization of the beam of light incident on the cell is parallel to the molecular orientation), that can be obtained at various voltages. It can be seen that at low voltages the scattering is confined to around 10°. At higher voltages than the scattered light spreads to larger angles extending to almost 90°. Hence, LC gels with such scattering properties are very suitable to be used as multi-purpose light module, for instance as interior car lighting, since such an anisotropic scattering pattern ensures that the driver is not dazzled as a result of broadened beam shape.

Further, FIG. 5 depicts the transmittance for a cell with a LC gel according to an embodiment of the invention as described above as function of voltage. There is some hysteresis, the higher curve obtained when increasing the voltage over cell 10 and the lower curve obtained when subsequently decreasing the voltage.

By for example supplying an alternating current voltage with an adjustable amplitude to the liquid crystalline cell 10 (or element), collimation and beam shape of the resulting beam of light can be adjusted. Hence, in a specific embodiment, the cell(s) is (are) operated by a root mean square (rms) voltage which is larger than 0 V and equal to or smaller than 60 V. Preferably, the voltage applied over a LC cell of the light module is between about 0.1 and 25 V, more preferably between about 0.2 and 20 V(rms), even more preferably below about 12 V(rms) (voltage of the car battery). In this way, a light module may be provided wherein the light module has a scattering angle θ equal to or larger than 5° and smaller than 90°. The frequency of the field applied is preferably between about 50 Hz and 100 kHz and it has preferably a square waveform, as known to the person skilled in the art.

Hence, in a variant, there is provided a light module 1 arranged to produce a beam of light 25 with electrically variable scattering pattern (i.e., amongst others electrically variable scattering angles φ,θ and intensity distribution) comprising a light source 2 arranged to provide a beam of light 5 and an electrically adjustable optical element arranged to adjust the beam of light 5 from light source 2, the electrically adjustable optical element comprising a cell 10 with a liquid crystal gel 11, a unit for applying a voltage across cells 10, and wherein cell 10 is arranged such that the light module 1 provides a beam of light 15 with an anisotropic light distribution.

Preferably, the LC cell of the light module contains an anisotropic liquid crystal gel, more preferably uniaxially oriented anisotropic liquid crystal gel selected from the group consisting of liquid crystal gels with a positive or a negative dielectric anisotropy. The term “positive dielectric anisotropy” refers to the dielectric constant parallel to the director being higher than the dielectric constant perpendicular to the director at a certain electric field frequency. “Negative dielectric anisotropy” refers to the opposite effect where the dielectric constant perpendicular to the director is higher than the dielectric constant parallel to the director at a certain electric field frequency. Liquid crystals may be selected from the group consisting of nematic, (super) twisted nematic, smectic, and cholesteric. The term “uniaxially oriented liquid crystal gel” refers to a LC gel wherein the director is oriented along a single axis.

However such a uniaxially oriented gel scatters only one polarization direction (vide supra). In order to scatter both polarization directions preferably two cells are used. In an embodiment, the cells are arranged next to each other or on top of each other, and arranged such, that the orientation direction of the molecules is perpendicular to each other. In such a configuration both polarization directions are scattered.

An embodiment of such a configuration is shown in FIG. 6a. Light source 2 is arranged to provide a beam of light 5, which may optionally be influenced by passive beam shaping element 3, for instance a collimator arranged to collimated beam 5. Beam of light 5 enters first cell 10 with first liquid crystal gel 11. Preferably, liquid crystal gel 11 is an anisotropic liquid crystal gel, more preferably an uniaxially oriented anisotropic LC gel, even more preferably a liquid crystal gel comprising nematic liquid crystals. Over cell 10, a voltage may be applied, which, when applied, provides a beam 15 with anisotropic light distribution. The orientation direction of the LC molecules in the gel is indicated with director 12. At least part of beam 5 is transmitted through cell 10, wherein one polarization component is scattered as described above (the component parallel to director 12; see also for instance FIG. 3), and the other polarization component is substantially unscattered. The transmitted beam of light is indicated with reference number 15. Beam of light 15 enters second cell 20 with second liquid crystal gel 21. Preferably, liquid crystal gel 21 is also an anisotropic liquid crystal gel, more preferably an uniaxially oriented anisotropic LC gel, even more preferably a liquid crystal gel comprising nematic liquid crystals. Also over cell 20, a voltage may be applied, which, when applied, provides a beam 25 with anisotropic light distribution. The orientation direction of the LC molecules (for instance Ω=45°, see also above) in the gel 21 is indicated with director 22. Since the orientation 22 of the LC molecules in 21 is perpendicular to orientation 12 (i.e. Ω135°), now beam of light 25, transmitted through second cell 20 will show an orthogonal scattering pattern; i.e. referring to FIG. 3, a scattering pattern 210 will be found comprising two scattering areas, one as depicted in FIG. 3, and one orthogonal to the one depicted in FIG. 3. Referring to FIG. 3, an orthogonal scattering pattern (or crossed lines pattern) may be found with orthogonal scattering areas extending to φ of about 135° or 315° (as depicted and as obtained after first 10) and to φ of about 45° or 225° (not depicted, obtained after second cell 20).

Note that directors 12 and 22 in the figures are drawn schematically and do not necessarily represent the herein mentioned angle Ω of for instance 45° and 135°.

Hence, according to an embodiment, light module 1 is provided, wherein the light module 1 is arranged to produce a beam of light 25 with electrically variable scattering pattern (i.e. amongst other, φ and θ are controllable) comprising a light source 2 arranged to provide a beam of light 5 and an electrically adjustable optical element 300 arranged to adjust the beam of light 5 from light source 2, wherein electrically adjustable optical element 300 comprises first cell 10 with first liquid crystal gel 11, second cell 20 with a second liquid crystal gel 21 and a unit for applying a voltage across at least one of the first and second cells 10,20, wherein the first and the second cells 10,20 are arranged such that the light module 1 provides a beam of light 25 with an anisotropic light distribution (i.e. anisotropic scattering pattern).

By adjusting the voltage over cells 10 and 20, the shape of scattering pattern 210 can be tuned (see also FIG. 4 for one cell), i.e. by electrically adjusting optical element 300, φ, θ, intensity distribution and the light output can be varied to obtain a desired scattering pattern 210 of the anisotropic scattered light of beam of light 25.

Even more preferably two cells 10,20 are used, wherein the cells 10,20 are placed on top of each other or next to each other but in between the cells a polarization rotator 30 is arranged, as schematically depicted in FIG. 6b. In a specific embodiment, light module 1 is provided, wherein the polarization rotator 30 is selected from the group consisting of a lambda/2 plate (half wave plate) and a (super) twisted nematic liquid crystal cell or liquid crystal polymer or a polymer network obtained by polymerization of reactive LC material.

Referring to FIG. 6b, when optical axis 32 of the half wave plate is set to be 45° (α) with respect to the orientation directions 12,22 of the molecules in the gels, advantageously both polarization components can be scattered in the same direction and overlapping scattering patterns 210 may be provided. The same effect can be obtained when using a (super) twisted nematic liquid crystal cell or polymer layer as polarization rotator. Half wave plates are commercially available, also for a broad wavelength range (for instance, source 2 may provide white light).

By using polarization rotator 30, in a configuration as schematically depicted in FIG. 6b, the unscattered light having a polarization perpendicular to the molecular orientation 12 (referring to FIG. 2, this is the polarization component wherein angle Ω between the polarization component of the light and the molecular orientation 12 is 90° or almost 90° (or 270° or almost 270°), may be rotated such that its polarization is now parallel to the molecular orientation 12 in cell 10. This means that the polarization component which is unscattered in beam of light 35 after polarization rotator 30 is parallel to the molecular orientation 12 in cell 10. Hence, when beam of light 35 enters second cell 20 (of the electrically adjustable optical element 300) containing a liquid crystal gel 21 with a polarization direction 22 parallel to polarization direction 12 (and thus also parallel to the polarization direction of the unscattered light in beam of light 35), the polarization component will also be scattered, similar as described above, providing a scattering pattern similar 210 to the scattering pattern 210 obtained after cell 10 for the other polarization component, thereby providing scattering patterns 210 that overlap or substantially overlap. Hence, the scattering pattern 210 in FIG. 3 may in this embodiment also represent the overlapping scattering pattern obtained after cell 20, and wherein scattering pattern 210 is the cumulative of both polarization components. Advantageously, using such electrically adjustable optical element 300 provides an even better result because substantially all light of beam of light 25 is anisotropically scattered and an anisotropic light distribution is obtained. The scattering angles φ, θ, of this beam can be tuned by varying the voltages applied over both cells 10,20 and by polarization rotator 30. One can also use any other angle between the orientation directions 12,22 and using rotator 30 still get both polarizations scattered while having two scattering patterns rotated with respect to each other.

Hence, in a specific embodiment, the invention provides light module 1 arranged to produce beam of light 25 with a scattering pattern that is electrically variable, the light module 1 comprising a light source 2 arranged to provide beam of light 5 and electrically adjustable optical element 300 arranged to adjust beam of light 5 from light source 2, wherein electrically adjustable optical element 300 comprises first cell 10 with a first liquid crystal gel 11, polarization rotator 30, second cell 20 with second liquid crystal gel 21, and a unit 40 for applying a voltage across at least one of the first and second cells 10,20, wherein the first and the second cells 10,20 and polarization rotator 30 are arranged such that light module 1 provides a beam of light 25 with an anisotropic light distribution. Especially, a) cell 10, liquid crystal gel 11 and the orientation 12 of the molecules of LC gel 11, b) the polarization rotator 30 and c) cell 20, liquid crystal gel 21 and the orientation 22 of the molecules of LC gel 21 are arranged such, that both polarization components of beam of light 5 are anisotropically scattered. Even more preferably, they are arranged such that the unscattered polarization component of beam of light 15 after first cell 10 is rotated such by polarization rotator 30, and scattered such by liquid crystal gel 21 in cell 20, that scattering patterns 210 of both polarization components in beam of light 25 overlap. Hence, preferably polarization rotator 30 rotates the polarization direction of the unscattered polarization component with 90°.

Unit 40 may be integrated in the light module 1, but may also be remote, as will be clear to the person skilled in the art. For instance, unit 40 may be a car battery. Unit 40 may also comprise a number of voltage sources.

If both polarization components need to be effected, adjustable optical element 300 comprising cells 10,20 is preferably be used in a configuration where the orientations 12,22 of liquid crystal molecules in the gels 11,21 in the cells 10,20 are orthogonal to each other (crossed scattering pattern, see above). However, more preferably in both cells 10,20 the orientation direction 12,22 of the molecules is kept the same, however in that case preferably rotator 30, like a half wave plate, is arranged between cells 10,20 and arranged such, that the unscattered polarization component is rotated 90°, thereby providing overlapping scattering patterns 210 of both polarization components. Hence, in order to scatter both polarization components a double cell configuration with cells 10,20 and polarization rotator 30 can be used.

In a preferred embodiment, in light module 1 the first and second liquid crystal gels 11,21 are anisotropic liquid crystal gels. Preferably, the first and the second liquid crystal gels 11,21 independently comprises liquid crystals selected from the group consisting of nematic, smectic, and chiral liquid crystals, preferably in a uniaxial or in a twisted configuration.

In a specific embodiment for anisotropic scattering, the first and the second liquid crystal gels 11,21 independently comprise an uniaxially oriented liquid crystal gel selected from the group consisting of anisotropic liquid crystal gels with a positive or a negative dielectric anisotropy. When using negative dielectric anisotropic LC gels, preferably the LC molecules are aligned with a relatively high tilt angle, preferably equal to or larger than 75°, more preferably equal to or larger than 80°, more preferably smaller than 89°. Gels with positive dielectric anisotropy are preferred as they are more readily available and show high birefringence which is advantageous for a large scattering effect and a high dielectric anisotropy which is advantageous for low switching voltages.

In yet another specific embodiment the first or the second or both liquid crystal gels 11,21 comprise a nematic liquid crystal gel, more preferably both liquid crystal gels 11,21 comprise a nematic liquid crystal gel. In yet another specific embodiment, the first or the second or both liquid crystal gels 11,21 comprise a liquid crystal gel in a twisted configuration. Preferably nematic materials are used as they show lower viscosities and faster switching times. An advantage of using (super) twisted nematic cells is that shape of scattering pattern 210 can be further influenced. In general, the higher the twist angle (ranging from 0 to 90°), the broader scattering pattern 210. As will be clear to the person skilled in the art, combinations of cells 10,20 with different types of LC gels 11,21 are possible. For instance, first cell 10 may comprise a nematic liquid crystal gel and second cell 20 may comprise a twisted nematic liquid crystal gel.

Preferably, the voltage applied over cell 10 or cell 20 or both cells 10, 20 is larger than 0 V and equal to or smaller than 60 V.

In this way, a light module 1 is provided wherein for instance advantageously scattering angle θ is electrically variable in the range from 5° or larger and smaller than 90°. Also advantageously, scattering angle φ may be tuned, for instance by selecting one of cells 10,20 (or both) and/or rotator 30 to contain twisted nematic liquid crystals. Further, these scattering angles θ,φ and the intensity distribution in scattering pattern 210 can be controlled by the voltage applied over cells 10 and 20, respectively. Hence, in an embodiment, electrically adjustable optical element 300 may be arranged and used to provide adjusted light comprising beam of light 25 with an adjustable cone angle and/or an adjustable direction to achieve optimized illumination of a large variation of objects (i.e. angles θ, φ and the intensity distribution of scattering pattern 210 is adjustable). In yet another embodiment, electrically adjustable optical element 300 may be arranged and used such to provide adjusted light comprising beam of light 25 with an adjustable aspect ratio of the light beam, e.g. 4:3 or 16:9 aspect ratios, to 15 adapt the beam shape to a selected aspect ratio of the object to be illuminated, like doorways, parts of (car) interiors, entrances, etc.

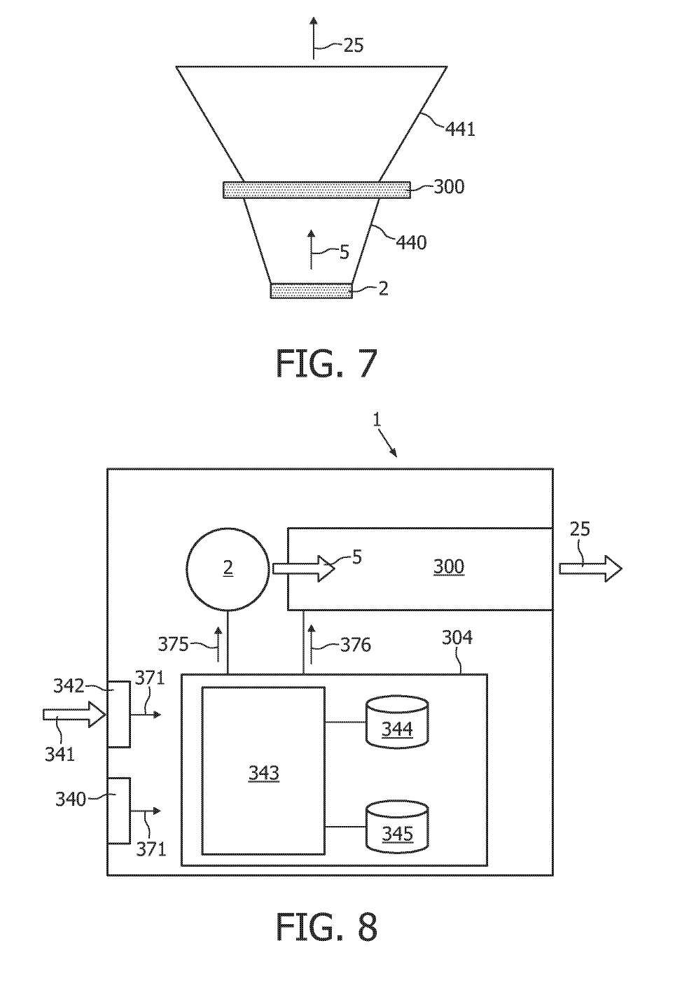

Therefore, in an embodiment electrically adjustable optical element 300 is provided that can control the light distribution and/or its shape of beam of light 25 and can be placed in front of light source 2. This can be a collimated light source 2, collimated by collimator 3. However the electrically adjustable optical element 300 used for collimating and shaping the light can also be placed between light source 2 and a passive beam shaping element or in case of more than one passive beam shaping elements between the passive beam shaping elements. Referring to FIG. 7, in an embodiment, light source 2, like a light emitting diode, a reflector 440 (which may be comparable to passive beam shaping element 3 in FIGS. 6a and 6b) and/or 441 with a certain shape can be used in order to obtain a light shape with a certain distribution. Adjustable optical element 300 can therefore be placed between passive beam shaping elements 440 and 441. The passive beam shaping elements 440,441 can also consists of several segments and the electrically adjustable optical element 300 can be placed at any place along the passive beam shaping elements 440 and 441. More than one passive beam elements may be comprised in light module 2, as in an embodiment shown in FIG. 8 with passive beam shaping elements 440 and 441. Note that FIG. 11 only shows the source, adjustable optical element 300 and passive beam shaping elements 440 and 441. Other elements like a controller 304, etc, are not shown in this Fig.

Further, in an embodiment only one or more passive beam shaping element(s) are present between source 2 and adjustable element 300, as for instance shown in FIGS. 12a and 12b (see below).

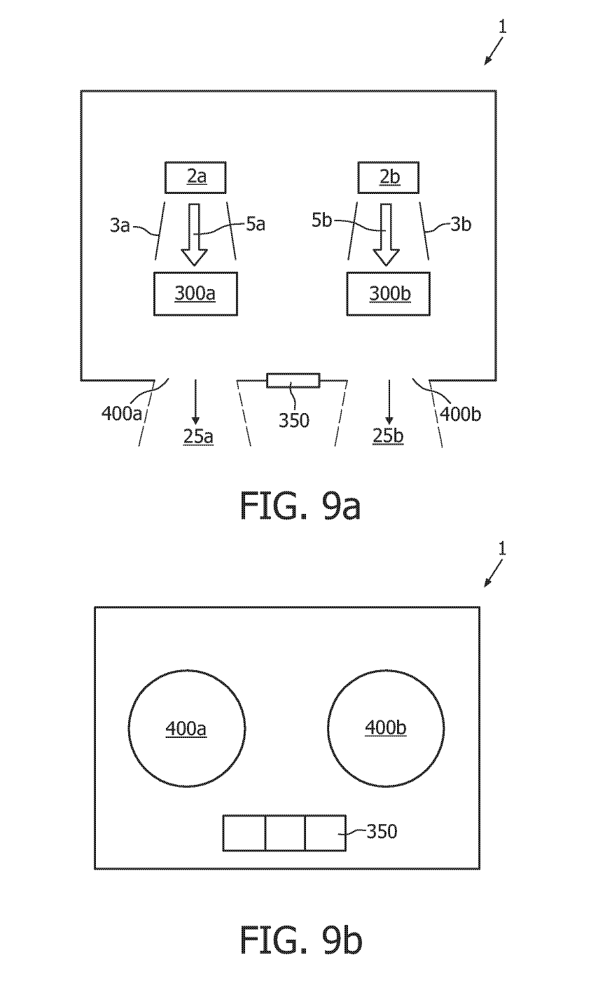

Referring to FIG. 8, in yet a further aspect of the invention, light module 1 further comprises a controller 304 arranged to, in response to an adjusting control signal 371, control at least one element of a group of elements comprising the electrically adjustable optical element 300 and the light source 2 via at least one driving signal 375, 376. An embodiment of light module 1 according to the invention is shown in FIG. 9 comprising a light source 2 for illuminating an object (not shown) and comprises an electrically adjustable optical element 300 for adjusting light 5 originating from the light source 2 and for supplying adjusted light 25 to the object. A controller 304 controls the electrically adjustable optical element 300 via a driving signal 376 and/or light source 2 via a driving signal 375 in response to an adjusting control signal 371. Driving signal 376 may comprise more than one driving signal, for example driving signals to control the voltage over cell 10 and over cell 20.

Light source 2 is for example a flash light source or a continuous light source and may comprise a light emitting diode or an array of diodes. In a preferred embodiment, driving signal 75 to control light source 2 is able to control light emitting diodes of an array of light emitting diodes individually in order to provide colored light 25 or light 25 with adjustable color temperature, if the array of diodes comprise diodes emitting light with different colors. In a specific embodiment, the controller 304 comprises a processor 343 coupled to an interface 340 for receiving the adjusting control signal 371, optionally to an input interface 342 to receive the adjusting control signal 371 from a user 341 to for instance a short-term memory 344 and/or to a long-term memory 310. The present light module 1 does for instance not require to shift a lens by hand for adjusting the beam of light 25 originating from light source 2 or to adjust the required intensity of light manually (although the latter may still optionally be done, see below). Instead of that, controller 304 offers the possibility of adjusting light intensity and beam shape of beam of light 25 originating from light source 2 in a more automatic way. As a result, light module 1 according to an embodiment of the invention is more user friendly. Alternatively and/or yet further in addition, the further adjusting control signal 371 is for example generated by the user, to inform the controller 304 (in an embodiment the processor 343) of the user's preferences. Light intensity may be controlled by adjusting the power delivered to light source 2 and/or by the voltage applied over the liquid crystal cells 10 and/or 20 (see also FIGS. 4 and 5).

The module may further comprise one or more switches or one or more sensors or both one or more switches and sensors, wherein the switches provide the functionality of one or more functionalities selected from the group comprising:

switching on and off source 2;

electrically adjusting electrically adjustable optical element 300, (for instance the passenger adjusting the source from a comfort light properties (scattered) to a reading light properties (unscattered);

adjusting the scattering properties of the beam of light 25;

adjusting the light intensity of beam of light 25;

and wherein the sensors provide the functionality of one or more functionalities selected from the group comprising:

detecting one or more of opening, closing, locking and unlocking of one or more doors;

detecting a remote signal for one or more of opening, closing, locking and unlocking of one or more doors;

detecting the presence of a driver and/or one or more passengers;

detecting driving (for instance used to give a signal 376 to block the non-scattering function for a beam 25 of light directed to the driver);

detecting a remote control signal intended to control one or more of the same functionalities as described above for the switches (for instance a sensor sensing a remote control giving a signal for a change from reading light properties (unscattered or substantially unscattered) to comfort light properties (scattered) of the same beam 25).

The invention provides in an embodiment light module 1 for light with a scattering pattern that is electrically variable comprising:

light source 2 to emit light 5;

electrically adjustable optical element 300 (also called adjustable optical element) for adjusting the light 5 originated from the light source 2 into adjusted light 25; and

a controller 304 for, in response to an adjusting control signal 371, controlling at least one element of a group of elements comprising the adjustable optical element 300 and the light source 2 via at least one driving signal 375, 376.

According to yet another aspect of the invention, a computer program product is provided, to be run on controller 304, the computer program product comprising the function of, in response to adjusting control signal 371, controlling at least one element of a group of elements comprising the electrically adjustable optical element 300 and the light source 2 via at least one driving signal 375, 376 of at least one light module 1. Such computer program product may also control 2 or more light modules 1. Adjusting control signal 371 may be provided by a user, for instance a user who want to increase or diminish the light output of light module 1, but may also “automatically” be generated, for instance a signal based on a sensor (not depicted), detecting that a door is opened, etc.

According to yet another embodiment, as schematically depicted in FIGS. 9a and 9b, the light module 1 according to the invention provides more than one beams of light 25 (i.e. two or more beams of light 25 with electrically variable scattering patterns are provided), here indicated with reference numbers 25a and 25b, wherein the light module 1 preferably comprises more than one sources 2, indicated with 2a and 2b, arranged to provide more than one beams of light 5 (indicated with 5a and 5b) and more than one electrically adjustable optical elements 300, indicated with reference numbers 300a and 300b arranged to adjust the more than one beams of light 5 from the more than one light sources 2 into more than one adjusted beams of light (25). This light module 1 may further comprise a controller 300, for, in response to an adjusting control signal 371, controlling at least one element of a group of elements comprising one or more adjustable optical elements 300 and one or more light sources 2 via at least one driving signal 375,376.

As will be clear to the person skilled in the art, one may use one source and one or more beam splitters or other means known to the person skilled in the art, to provide more than one beams of light 5. Preferably each beam of light 5 (5a, 5b, etc.) is addressed individually by an adjustable optical element 300 (300a, 300b, etc.), such that controllable beams of light 25 (i.e. 25a, 25b, etc.) are provided by the module.

Hence, herein the terms “beam of light 25”, “driving signal 375”, “driving signal 376, “source 2”, “collimator 3”, “beam of light 5”, etc. also refer to “beams of light 25”, “driving signals 375”, “driving signals 376, “sources 2”, “collimators 3”, “beams of light 5”, etc., respectively or to “at least one of the beams of light 25”, “at least one of the driving signals 375”, “at least one of the driving signals 376, “at least one of the sources 2”, “at least one of the collimators 3”, “at least one of the beams of light 5”, etc., respectively.

FIG. 9a schematically depicts a module having 2 sources 2a and 2b, although more sources can be used (for instance to provide a module with 3 beams of light 5 and consequently 25). Beam of light 5 from the sources 2a,2b may optionally be collimated with collimators 3, indicated with reference numbers 3a and 3b. The beams of light 5a and 5b are interrupted by electrically adjustable optical elements 300 (i.e. 300a and 300b, respectively), such that the properties of the beams of light 25a and 25b can be controlled. Reference 400 (here reference number 400a and 400b) reflects the place in the module 1 where the beams of light 25 are provided to the exterior of the module 1 and are also called exit(s) 400. This may for instance be a lens, a transparent glass, a transparent plastic or polymer cover, it may be a transparent glass plate of a cell containing the LC molecules (for instance from cell 20), etc. As will be clear to the person skilled in the art, exit(s) 400 may have all kind of suitable shapes, like round, square, elliptical, etc.

In this way, a light module 1 is provided wherein the module 1 provides more than one beams of light 25, the light module 1 preferably comprising more than one sources 2 arranged to provide more than one beams of light 5; and more than one electrically adjustable optical elements 300 arranged to adjust the more than one beams of light 5 from the more than one light sources 2. The term “more than one” is equivalent to “two or more”. Preferably, the module provides 2-6, more preferably 2-4, even more preferably 2-3 beams of light 25 of which the properties are electrically variable in the sense the amongst others intensity and scattering can be controlled.

Further, the module 1 may comprise one or more sensors and/or one or more switches 350. These sensors or switches 350 may be present on or in the module 1, but may also be present for instance on a dashboard of a car or elsewhere. For example, module 1 for use in a car may comprise a sensor 350, the sensor located in the door or doorways of the car and arranged to sense opening of the door. The sensor provides a signal 371 which may used by controller 304 to switch on one or more of the lamps 2a,2b and provide beams of light 25a and 25b, which may for instance scattered (approaching light function) by driving signal 376 (and 375). The module 1 may alternatively or in addition also comprise a sensor sensing a remote unlocking of the door(s). While driving, a beam of light 25 directed to the driver may be scattered according to the invention, such that the driver may not be dazzled. A person next to the driver may use the other beam of light, for instance unscattered, to read.

Assuming for instance that the module comprises switches 350, for instance 3 switches (as schematically indicated in FIG. 9b), the switches can be used to switch on various elements. With a first switch both sources 2a,2b (for instance LEDs) can be switched on and at the same time the scattering state of LC cell is activated (providing comfort light and approaching light functions). There may optionally be a control that when the central door key is activated the sources 2a,2b can be switched on and at the same time the scattering state of LC cell (approaching light function) is switched on. The other switches can be used to switch lamp 2a (a second switch) and lamp 2b (a third switch) on and off individually, respectively, when scattering function is deactivated (reading light function). As will be clear to the person skilled in the art, one may also use for instance one switch, like a touch control etc., providing a number of functionalities, supported by controller 304. For instance, one touch: both sources 2a,2b (for instance LEDs) can be switched on and at the same time the scattering state of LC cell is activated; two/three touches: switch lamp 2a and lamp 2b on and off individually, respectively, when scattering function is deactivated; four touches: all lamps off.

As will be clear to the person skilled in the art, the switches may be for instance be touch switches or slide switches, which may provide multiple functionalities (see above) for the multiple purpose light (for instance for addressing both sources at the same time and both sources individually) and can be variable switches. In this way a user 341 may give a signal 371 to a controller 304, which may address the sources 2 via driving signals 375 and the adjustable elements 300 via driving signals 376, respectively.

In general, the module 1 in this embodiment and variations thereon, comprises source(s) 2, arranged to generate two or more beams of light 5, optionally two or more collimators 3 arranged to collimate the two or more beams of light 5, two or more electrically adjustable optical elements 300 arranged to adjust the two or more beams of light 5 from the two or more light sources 2, thereby providing two or more beams of light 25 with a scattering pattern that is electrically variable. The module further comprises one or more switches or one or more sensors 350 or both one or more switches and sensors 350, wherein the switches provide the functionality of one or more functionalities selected from the group comprising:

switching on and off sources 2, preferably each source of the two or more sources individually (for instance a passenger switching on and off his source only, for instance for reading a map);

switching on and off two or more of the sources at the same time (for instance switching on all sources 2 at the same time);

electrically adjusting the two or more electrically adjustable optical elements 300, preferably each switch (i.e. variable switch) of the two or more switches adjusting one of the two or more electrically adjustable optically elements 300 individually (for instance the passenger adjusting the source from comfort light properties (scattered) to a reading light properties (unscattered);

adjusting the scattering properties of the two or more beams of light 25; adjusting the light intensity of the two or more beams of light 25;

and wherein the sensors provide the functionality of one or more functionalities selected from the group comprising:

detecting one or more of opening, closing, locking and unlocking of one or more doors;

detecting a remote signal for one or more of opening, closing, locking and unlocking of one or more doors;

detecting the presence of driver and/or one or more passengers; detecting driving (for instance used to block the non-scattering function for a beam of light directed to the driver);

detecting a remote control signal intended to control one or more of the same functionalities as described above for the switches (for instance a sensor sensing a remote control giving a signal for a change from reading light properties (unscattered or substantially unscattered) to comfort light properties (scattered) of the same beam 25).

Hence, the light module 1 according to the invention may further comprise one or more switches or one or more sensors 350 or both one or more switches and sensors 350, wherein the one or more switches (350) provide one or more functionalities selected from the group comprising switching on and off one or more sources 2; optionally switching on and off one or more sources 2 at the same time (in case more than one source is present); electrically adjusting one or more electrically adjustable optical elements 300; adjusting the scattering properties of one or more beams of light 25; adjusting the light intensity of one or more beams of light 25; and wherein the one or more sensors 350 provide one or more functionalities selected from the group comprising: detecting opening and/or closing one or more doors; detecting a remote signal for opening and/or closing one or more doors; detecting the presence of driver and/or one or more passengers; detecting moving (for instance driving); detecting a remote control signal intended to control one or more of the functionalities as described for the switches 350.

In general, such module 1 may be intended to be arranged on an interior roof part of a car, with the beams of light directed to the driver seat and to one or more passenger seats, respectively, or to be arranged on an interior roof part of a car, with the beams of light directed to back seats, respectively. As will be clear to the person skilled in the art, module 1 may comprise more than two sources 2, for instance a module intended for arrangement in a car wherein three persons sit on a row, like some cars have, or which may be the case in the back seat of a car, or for instance a module intended for arrangement in an air plane over a row of seats. Where the module is intended for arrangement in a car with a beam of light directed to the driver, preferably at least the optical module 300 for controlling the beam of light 25 directed to the driver may provide an anisotropic light distribution when driving the car.

Therefore, preferably the first and the second cells 10,20 and the optional polarization rotator 30 of at least one optical element 300 are arranged such that the light module 1 is able to provide at least one light beam 25 with an anisotropic light distribution.

Herein the term “controller” may include an on/off switch, a variable switch or a controller like a computer, such controller comprising a processor and for instance one or more sensors having functionalities selected from the functionalities described above.

In a specific embodiment, light module 1 may provide a scattering pattern of beam 25 (or of at least one beam 25 in case a module 1 is used providing more than 1 beam 25) with an isotropic light distribution.

Herein, light module may also be called an illumination device (for illuminating an object).

As will be clear to the person skilled in the art, the phrase “a light module comprising a controller” or “the light module comprising a switch or sensor”, or “the optical element comprising a unit for applying a voltage” does also include embodiments wherein the controller 304, switch or sensor 350, and/or voltage unit 40 are remote from the light source (and adjustable element 300). For instance, the module 1 comprising the light source 2 and the adjustable element are arranged at an interior car roof, and the switch or sensor 350 are placed at a dashboard, etc. One controller 304 may control more than one module 1, i.e. it controls for instance a number of lights 2 via signal 375 and adjustable elements 300 which are arranged at a number of places in a car or plane, etc.

According to a further aspect, the invention provides also an electrically adjustable optical element 300 for adjusting beam(s) of light 5 from light source(s) 2 into adjusted beam(s) of light 25, the optical element 300 comprising:

1. a first cell 10 with a first liquid crystal gel 11;
2. optionally a polarization rotator 30;
3. a second cell 20 with a second liquid crystal gel 21; and
4. a unit 40 for applying a voltage across at least one of the first and second cells 10,20.

Together with one or more light sources 2, and optionally one or more passive beam shaping elements, the electrically adjustable optical element(s) 300 can be used to adjust (accommodate) the beam(s) of light 5 such that the desired scattering properties are obtained.

A liquid crystal gel for use in the invention was obtained by using a mixture containing 4% reactive LC molecule C6M in BL006 obtainable from Merck (Darmstadt). The mixture was provided with 0.5% photo initiator Irgacure 651 (Ciba Geigy). The mixture was brought into a cell with indium tin oxide (ITO) transparent electrodes and uniaxially rubbed PI surfaces. After inducing uniaxial orientation, the polymerisation was induced at room temperature using UV light from a TL lamp with an emission maximum at 365 nm at 1 mW/cm².

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. Use of the verb “to comprise” and its conjugations does not exclude the presence of elements or steps other than those stated in a claim. The article “a” or “an” preceding an element does not exclude the presence of a plurality of such elements. The invention may be implemented by means of hardware comprising several distinct elements, and by means of a suitably programmed computer. In the device claim enumerating several means, several of these means may be embodied by one and the same item of hardware. The mere fact that certain measures are recited in mutually different dependent claims does not indicate that a combination of these measures cannot be used to advantage.

1-17. (canceled)

18. A light module (1) arranged to produce a beam of light (25) with a scattering pattern that is electrically variable comprising:
a. a light source (2) arranged to provide a beam of light (5); and
b. an electrically adjustable optical element (300) arranged to adjust the beam of light (5) from light source (2) comprising:
1. a first cell (10) with a first liquid crystal gel (11);
2. optionally a polarization rotator (30);
3. a second cell (20) with a second liquid crystal gel (21); and
4. a unit (40) for applying a voltage across at least one of the first and second cells (10,20);
wherein the first and second liquid crystal gels (11,21) are anisotropic liquid crystal gels.

19. The light module (1) according to claim 18, wherein the first and the second cells (10,20) and the optional polarization rotator (30) are arranged to modify the beam of light (5) into a beam of light (25) with an anisotropic light distribution.

20. The light module (1) according to claim 18, wherein the first and the second liquid crystal gels (11,21) independently comprises liquid crystals selected from the group consisting of nematic, twisted nematic, smectic, and cholesteric liquid crystals.

21. The light module (1) according to claim 18, wherein the first and the second liquid crystal gels (11,21) independently comprise an uniaxially oriented liquid crystal gel selected from the group consisting of liquid crystal gels with a positive or a negative dielectric anisotropy.

22. The light module (1) according to claim 18, wherein the first or the second or both liquid crystal gels (11,21) comprise a nematic liquid crystal gel.

23. The light module (1) according to claim 18, wherein the first or the second or both liquid crystal gels (11,21) comprise a twisted nematic liquid crystal gel.

24. The light module (1) according to claim 18, operated by a root mean square voltage which is larger than 0 V and equal to or smaller than 60 V.

25. The light module (1) according to claim 18, wherein the scattering pattern has a scattering angle θ which is electrically variable in the range from 5° or larger and smaller than 90°.

26. The light module (1) according to claim 18, wherein the polarization rotator (30) is selected from the group consisting of a lambda/2 plate and a (super) twisted nematic liquid crystal cell.

27. The light module (1) according to claim 18, further comprising a controller (304) arranged to, in response to an adjusting control signal (371), control at least one element of a group of elements comprising the electrically adjustable optical element (300) and the light source (2) via at least one driving signal (375, 376).

28. The light module (1) according to claim 18, wherein light source (2) is selected from one or more of the group consisting of a halogen lamp, a xenon lamp, a LED, and a luminescent lamp.

29. The light module (1) according to claim 18, wherein the module provides more than one beams of light (25), the light module (1) preferably comprising:
a. more than one light sources (2) arranged to provide more than one beams of light (5); and
b. more than one electrically adjustable optical elements (300) arranged to adjust the more than one beams of light (5) from the more than one light sources (2) into more than one adjusted beams of light (25).

30. A computer program product to be run on a controller (304) according to claim 27, the computer program product comprising the function of, in response to an adjusting control signal (371), controlling at least one element of a group of elements comprising the electrically adjustable optical element (300) and the light source (2) via at least one driving signal (375, 376) of at least one light module (1).

31. An electrically adjustable optical element (300) for adjusting a beam of light (5) from a light source (2) into an adjusted beam of light (25), the electrically adjustable optical element (300) comprising:
1. a first cell (10) with a first liquid crystal gel (11);
2. optionally a polarization rotator (30);
3. a second cell (20) with a second liquid crystal gel (21); and
4. a unit (40) for applying a voltage across at least one of the first and second cells (10,20);
wherein the first and second liquid crystal gels (11,21) are anisotropic liquid crystal gels.

32. Use of a light module (1) according to claim 18 as multiple purpose light, preferably as multiple purpose interior car light.

33. Use according to claim 32, wherein the use of the light module is selected from the group consisting of reading light (102), vanity light (101) and stepping light (103).
